(19) United States
(12) Patent Application Publication
(10) Pub. No.: US 2011/0204086 A1
(43) Pub. Date: Aug. 25, 2011

(54) Refillable Container with a Graduated Neck Extension

(76) Inventor: Anthony A. Karam, Sterling Heights, MI (US)

(21) Appl. No.: 12/711,284

(22) Filed: Feb. 24, 2010

(51) Int. Cl. B67D 7/08; B67D 7/56

(52) U.S. Cl. 222/25; 222/158

(57) ABSTRACT

The invention is a container with a neck extension having a sight glass and containing indicia to enable a user to verify the liquid content of the container with a graduated level indicator. The container enables a user to verify whether when a gasoline pump indicator reflects the dispensing of one gallon of gasoline into the container. A liquid level indicator allows the user to verify whether the pump has accurately dispensed a gallon or whether the amount of gasoline received is less than one gallon.

### CROSS-REFERENCES TO RELATED APPLICATIONS

This application is related to U.S. Design Pat. No. D557,142 S issued on Dec. 11, 2007.

### FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention generally relates to a container which is provided with a graduated neck extension for the measurement of dispensed substances within the container. More specifically, this invention relates to a graduated neck extension attached to a specified volume container which provides the user of the container with the graduated neck extension the ability to validate the volume placed within the container while filling so as to ensure the correct amount of desired substances is placed within the container at the time of filling.

2. Description of the Related Art

Since the invention of internal combustion engines and gasoline, there has been a long history and use of containers which carry different fuels as such. Fuel became a commodity which was highly sought after to allow the wealthy to operate their new vehicles. There was little concern with the cost or amount of fuel which was delivered, but more so with the availability.

Now that most of the population has access to vehicles, the availability of different types and grades of fuel is not an issue with fuel stations at most major intersections and dispersed along most major highways. The United States has become a major consumer of fuels. (gasoline, diesel fuel, kerosene, etc.) This coupled with simple supply and demand economics has made fuel a major commodity in the world.

When fuel is sold to the consumer it is typically sold at a price per gallon or a price per liter rate. During the past 5 years of rising crude oil and fuel costs, some unscrupulous people have surfaced and tried to take advantage of others who do not know or are unable to determine the amount of fuel which they have pumped into their fuel containers of vehicles. This has been an issue since the advent of the fuel pump. It has become even more of an issue since the massive increase in fuel costs over the past few years. Unfortunately, the fine for a violation of improperly dispensing fuel is minor compared to the amount of money that is made by those choosing to defraud the consumer. In trying to protect the consumer this inventor has created a unique neck attachment to a fuel container which allows a user to validate the amount of fuel that is pumped from a gas pump into a storage container, thereby allowing the consumer to validate the price and amount indicated on the pump. One can then identify those people who are attempting to defraud the consumer.

One specific example that addresses the delivery of accurate, pure fuel is Rogers, U.S. Pat. No. 5,356,047, which discloses a consumer gasoline tester. The tester has, at the top, a funnel spout apparatus with a plastic nozzle stop at the base. The nozzle connects to a clear plastic container which has an easy-grip handle. The bottom of the container has a threaded hole for attaching a butterfly valve and draining hose. The container is clearly marked for precise measurement with quantity indicators. There is an additional flared-bottom container with a circular handle and screw-on cap to be used to temporarily store suspect gasoline. This patent is directed to a device wherein a consumer pumps fuel into a clear plastic container for inspection of the purity of the fuel. The container has quantity indicators on it and a butterfly valve such that the amount of fuel pumped may be verified simultaneously with the quality of the gasoline. The issue with this device is that the gasoline is only meant to be temporarily stored within the tester for the purposes of providing evidence of fuel fraud, and that the tester volume is relatively small compared to most long-term gasoline storage containers.

Beyond the above example there are few prior art references which address the potential of gasoline fraud. Many of the other references deal with either measuring a precise amount of fluid being dispensed from a container or measuring the amount of fuel in a container as a ratio of a second fluid within the same container. One such example is Levison, U.S. Pat. No. 5,295,610, which discloses a plastic gas can for the main purpose of blending 2 cycle fuel mixture and demarcation of ratio mixed by using an attached hinged cap with an integrated measuring cup. The cup is used to measure a second liquid like 2-cycle oil to be mixed with gasoline within the can. The issue with this device is that the demarcations on the plastic gas can are difficult to use since the color of the can must be a specified color as well as it is difficult to see the fuel level through the required material which the gas can must be made of for long term storage of gasoline.

Another example similar to the Levison patent is by Waring, U.S. Pat. No. 5,108,016, which discloses a container system for holding and dispensing an oil-gasoline mixture. This system uses a transparent container bearing indicia for the measurement of gasoline within the container, and an oil-measuring cup mounted to the fill cap so as to extend into the container when the cap is secured to the top of the container. The cup is also transparent and marked with indicia to measure an amount of oil to be mixed with the gasoline to obtain an oil-gasoline mixture. The issue with such a device for the purposes of validating the quantity of gasoline delivered is that the indicia is molded or written on the entire container. This does not allow a consumer to use the indicating device with different containers.

Another approach is to measure the quantity of fuel as it is being delivered. This approach is disclosed in U.S. Pat. No. 4,418,843, by Jackman which discloses a squeeze-bottle liquid-dispensing container for repeated delivery of a measured quantity of liquid. The container has a mouth and liquid-holding bottle which is connected to an integrally formed measuring and dispensing receptacle by a duct that is formed to have communication between the liquid-holding bottle and the dispensing receptacle. Additionally, the liquid-holding bottle and dispensing receptacle are connected by a neck which has a throat closed by a plug inserted within the mouth of the receptacle. This plug forces the liquid to travel through the duct and into the dispensing receptacle for accurate measurement of the liquid to be dispensed. The issue with this approach is that the user of such a device is only concerned with the measurement for dispensing of the liquid and there is no measurement of the total volume contained within the liquid-holding bottle portion. The liquid-holding bottle portion is still capable of not containing the advertised or indicated amount of liquid within the bottle. Additionally this invention was intended for a single use and then is to be discarded.

An additional reference that may be relevant is Barnett, U.S. Pat. No. 4,292,846, which discloses a liquid proportioning container consisting of a main reservoir and a measuring vessel calibrated and used to fill with one liquid to be proportioned to the liquid which will be filled within the main reservoir. The measuring vessel constitutes an intrinsic portion of the main reservoir. Additionally the vessel and reservoir are in communication which each other and may contain a filter or pouring spout. The main purpose of this container is for the mixing of lubricating oil and gasoline for two-cycle engines, although not limited to this use, it leads to similar issues found within the Levison and Waring patents aforementioned. Additionally, the issue with the Barnett reference is that the actual amount of fluid in the main reservoir is not known, only that you need to fill the reservoir to a particular mark on the container, and that the vessel too is not so marked with a true measurement for quantity contained within the vessel.

From the above, it can be appreciated that all of the prior art is not fully optimized to allow the consumer to accurately validate the larger quantities of fuel being pumped within a container which is meant for long term storage and allowing the consumer to identify potential fraudulent providers. Therefore, what is needed is a storage container which accurately identifies the volume of the liquid within the container and allows the user to compare that volume to the volume indicated on the pump delivering the liquid such that the user is able to validate the accuracy of the pump delivery and identify potential fraud.

### BRIEF SUMMARY OF THE INVENTION

According to the preferred embodiment of the present invention, there is provided a refillable container for the use of filling and storing of substances, preferably gasoline, diesel fuel, kerosene or the like. The refillable container includes a container body for holding a predetermined liquid substance. Additionally there is a graduated neck extension for the purpose of determining the exact amount of the liquid substance that is received from a dispensing device, i.e. gasoline pump, to ensure that the correct amount of liquid substance is received from the dispensing device. The neck extension cooperates with the container body to extend above the container body such that the liquid last fills the neck extension during the process of filling the container in a normal upright position. The actual amount of liquid substance received from the dispenser can then be validated first reading a temperature gage mounted atop of the spout of the body of the graduated neck extension of the container and thereafter comparing the actual liquid level in the container with the indicia of liquid ounces for the observed temperature of the liquid in the container as shown by the indicia on the neck extension if the container is intended to hold one gallon. Furthermore, there is a handle for the purpose of lifting the container for transportation. The handle is solid and connected to the container body solely, or both the container body and neck extension depending upon the variant used in connecting the neck extension to the container body. Finally, there is a cover which threads onto the container's neck extension to allow the user to sealably close the container for transportation or storage purposes so as to protect from spilling or evaporation of any substances stored within the container.

The refillable container with graduated neck extension is used by removing the cover containing a temperature gage and rim gasket from the spout opening and one gallon of fluid is pumped into the container through the spout opening located at the top of the neck extension. Upon dispensing the gallon of the fluid into the container, the fluid level will start to flow into the neck extension where a translucent or transparent sight glass allows the user to easily view the level of the liquid within the neck extension.

A temperature reading from the thermometer located within the cover atop the spout of the graduated neck extension of the container is then observed. The observed temperature is then viewed on the indicia of the neck extension and the actual level of fluid in the container is compared to the line which reflects what the level of fluid should be at the observed temperature. This line is then compared to the actual level of fluid as observed through the sight glass. The container may be used in one of two ways. The dispensing pump may be carefully throttled until the exact amount of liquid, i.e., one gallon as displayed by the price on the dispensing pump is dispensed into the container. If the liquid dispensed is gasoline, the pump is simply shut off at the dollar amount required to dispense one gallon. The temperature of the fluid dispensed from the dispensing pump is observed on the thermometer located atop the spout within the cover of the graduated neck extension of the container. Thereafter, the level of the liquid of the gasoline in the container is compared to the graduated indicia printed on the neck extension of the container at the indicated temperature as read on the thermometer of the container. This will visually determine whether the dispensing pump is correctly dispensing the amount of gasoline the customer is paying for.

Alternatively, the attendant is requested to automatically dispense one gallon of gas from the dispensing pump. The temperature of the incoming gasoline is read from the thermometer fixed within the cover of the neck extension of the container whereafter the pump is shut off. By viewing the level in the sight glass and comparing it to the indicia shown on the neck extension for the same temperature read from the thermometer, the customer can determine whether the pump is dispensing the correct amount of gasoline if the level of the liquid in the container reaches the indicia line at the indicated temperature.

At this point the user can compare the dispensed amount identified on the pump versus the amount measured within the container. If the amount is different, the name of the establishment can be reported to the proper authorities. The container complies with all legal safety requirements necessary to allow for long term storage of the gasoline liquid which was pumped into as well as allowing the user to safely transport the container within a vehicle.

It is an object of the present invention to provide a refillable container for the long term storage of fluids like gasoline, kerosene, and diesel fuel.

It is another object to provide a refillable container with a handle allowing a user to easily move and transport the container.

It is a still another object to provide a refillable container which allows a consumer or user of the container to determine if the dispenser of fluids such as gasoline, kerosene, and diesel fuel are dispensing the correct quantity of such fluid for the price paid by the consumer.

It is yet another object to provide a refillable container with a graduated neck extension having measuring indicia thereon for comparing a predetermined amount of fluid dispensed from a gasoline, kerosene or diesel fuel pump into the container and using the measuring indicia to confirm receipt of said predetermined amount of fluid.

It is a further object to provide a refillable container which incorporates a positive stop tab located such that when attaching a graduated neck extension to the container, the neck extension with measuring indicia will rest at the stop tab allowing accurate indication of the exact volume of fluid at a predetermined temperature received within the container.

It is still a further object to provide a refillable container that has an easy to use spout to allow the user to easily pour liquids from the container.

These objects and other features, aspects, and advantages of this invention will be more apparent after a reading of the following detailed description, appended claims, and accompanying drawings.

### BRIEF DESCRIPTION OF THE SEVERAL VIEWS OF THE DRAWINGS

FIG. 1 is a perspective view of a refillable container with a graduated neck extension, according to the invention.

FIG. 2 is an exploded perspective view of the refillable container with the graduated neck extension.

FIG. 3 is a right side orthogonal view of a variant of the refillable container with a permanently attached graduated neck extension welded into a unitary container including the sight view and handle.

FIG. 4 is a right side perspective view of another variant of refillable container constructed as a single blow-molded container. This view shows no threaded engagement of the neck extension and stop tab.

### DETAILED DESCRIPTION OF THE PREFERRED EMBODIMENT

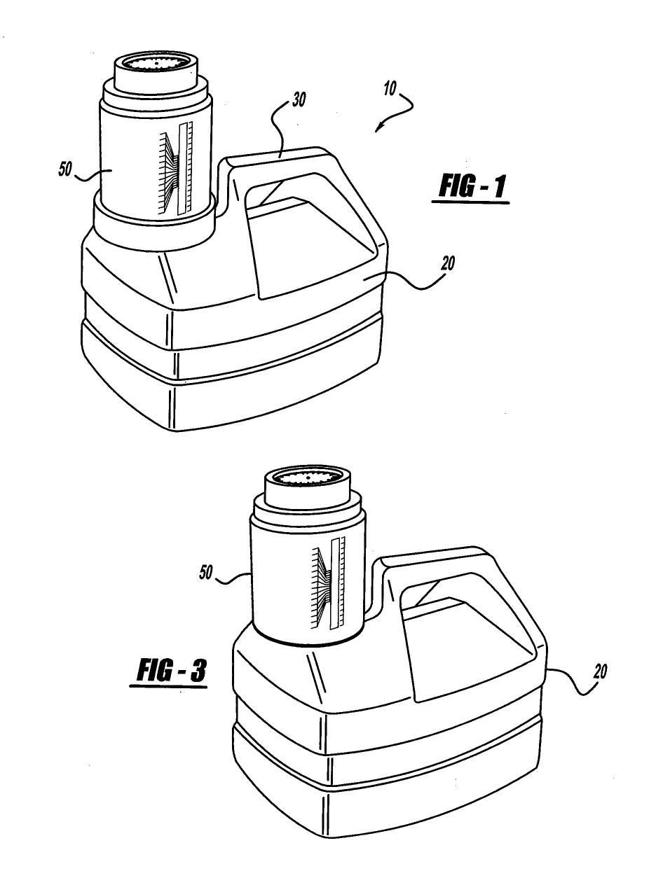

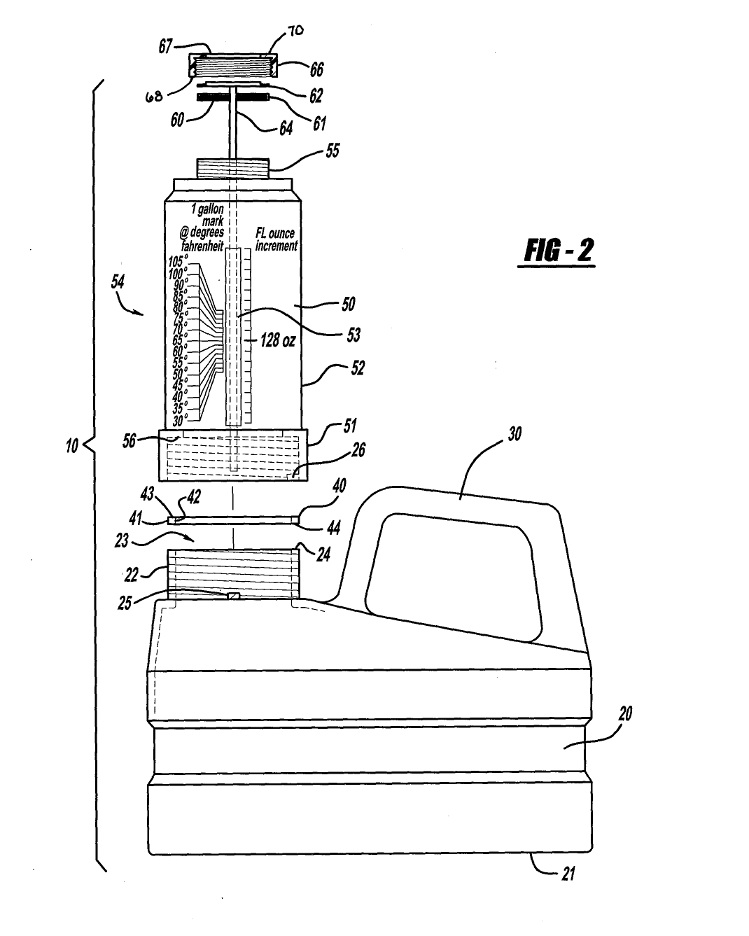

Referring now in detail to the Figures, there is shown in FIG. 1, a refillable container 10 with a graduated neck extension constructed in accordance with a method of the present invention. The container 10 generally includes a container body 20 for the storage of fluids, a handle 30 for the purpose of aiding in transportation of the container 10, a graduated neck extension 50 which is used to validate the amount of fluid received from a dispensing pump, a seal 40, shown in FIG. 2, to keep the fluid within the container from leaking out between the container body 20 and the graduated neck extension 50, and a cap or cover 66 which encloses a temperate gage 62 and rim gasket 60 located on the rim of the spout 55 of the graduated neck extension 50 to seal the container at its inlet point.

In FIG. 2, there is shown an exploded side view of the container 10 that is presented as a preferred embodiment of the current invention. The container body 20 is constructed by a blow molding process which can form a container volume, from about one gallon to ten gallons depending on the size desired by the user. (Most common is a container sized to hold three or five gallons of fluid). For the purpose of describing the preferred embodiment, a one gallon container will be described. Those skilled in the art will understand that the invention applies to any size container providing that the indicium marked on the neck of the container is adjusted to reflect the container size. The material used to construct the container 10 is a high density polyethylene plastic (HDPE) and is resistant to materials like gasoline, kerosene, diesel fuel, and the like. The container body 20 has a bottom 21 that is sufficiently wide to provide a stable base so that when the container 10 is resting on the ground, it is difficult to tip the container 10 over. The container body 20 also has a threaded flange inlet 22 located at the top of the container body 20 for the purpose of receiving and mounting a neck extension 50. The threaded flange inlet 22 is hollow and forms an inlet 23 which is used to allow fluid communication between the container body 20 and the neck extension 50. As shown, the threaded flange inlet 22 is cylindrical in shape, but the use of optional methods of attaching the neck extension 50 to the container body 20 can be used. Other methods of attaching the neck extension 50 to the container body 20 include gluing, welding, snapping, pressing, or bayonet lock can be used in place of the threaded connection. At the bottom of the threaded flange inlet 22 is a deliberately placed thread stop tab 25. The thread stop tab 25 is complemented by a stop tab 26 located along the bottom side of the neck extension either on the inside or outside surface of the neck extension 50 to ensure that when the neck extension 50 is threaded onto the container body 20 the thread stop tabs 25, 26 engage to prevent further rotation at the exact point of rotation where the indicia reads exactly 128 ounces when exactly one gallon of liquid is in the container at 65° F. This allows the manufacturer to accurately place the stop tab 26 against the stop tab 25 and seal the threaded joint of the neck extension 50 at a position exactly where the 128 ounce position level of the measuring indicia equals one gallon of fluid at 65° F. placed in the container and the sight glass 128 ounce line will line-up exactly with the liquid level in the container. Thereby an exact indication deliberately of one gallon of fluid filled in the container at 65° F. can easily be visualized.

The container also has a handle 30 attached to the top portion of the container body 20. The handle 30 can be attached by any means that allows a user to safely lift and transport the container 10. The handle 30 is made of the same material as the container and is preferably solid and molded directly with the container body. One of ordinary skill in the art can contemplate the handle 30 being made of any chemically resistant material and later attached to the container body if required.

Additionally shown in FIG. 2 is the graduated neck extension 50 which is threadably mounted to the container body 20 in this embodiment. The graduated neck extension 50 has a base 51, a body 52, and a spout 55. The base 51 of the graduated neck extension 50 has a cylindrical shape and is slightly larger in diameter than the body 52 of the graduated neck extension 50. This larger diameter creates an internal shoulder 56 at the top of the base 51 of the graduated neck extension 50. The base 51 of the graduated neck extension 50 has an internal thread for complimentary engagement to the threaded flange 22 of the container body 20.

At the top of the graduated neck extension 50 is the spout 55. The spout 55 is cylindrical in shape and has the same axis as the body 52 of the graduated neck extension 50. The spout 55 extends outwardly from the body 52 of the graduated neck extension 50. The spout 55 forms an edge upon which is located a rim gasket 60. A temperature gage 62 is mounted against the rim gasket 60 and has a probe 64 that extends into the body 52 of the graduated neck extension 50 well below the base 51 so that upon assembly of the cover 66 to the threaded spout 55, the probe 64 is well below the liquid level of the fluid in the container to sense the temperature of the liquid. An opening 67 in the cover 66 allows the thermometer 62 to be read by the user. The rim gasket 60 seals the cover 66 threaded to the spout 55. The outer diameter 61 of the rim gasket 60 is intended to create an interference fit with the root diameter of the threads within the cover or cap 66. Therefore, when the cover 66 is unscrewed from the spout 55, the rim gasket 60 and temperature gage 62 will remain within the cover 66 upon removal of the cover 66 from the spout 55.

The body 52 of the graduated neck extension 50 is cylindrical in shape and has a sight window 53 with indicia displayed alongside thereof. The sight window 53 is transparent or translucent such that a user can readily view the liquid level within the graduated neck extension 50 after the container 10 is filled. The sight window 53 is vertically displaced and aligned with the axis of the body 52 of the graduated neck extension 50 allowing the accurate viewing of the liquid level within the graduated neck extension 50 when the graduated neck extension 50 is securely attached to the container body 20. The neck extension indicia 54 is printed on the body 52 of the graduated neck extension 50 to indicate volume at specified temperatures within the container when the graduated neck extension 50 is securely mounted to the container body 20 and filling the container 10 with a predetermined amount of liquid (i.e., one gallon). The indicia shown on the left side in FIG. 2 reflects the level of one gallon of gasoline at a specified temperature of the fluid. In other words, the temperature coefficient of expansion of gasoline is taken into consideration when filling the container 10 by the use of the thermometer 62 mounted within the graduated neck extension 50 of the container 10. For example, the user can request from the attendant that the dispensing pump be set to deliver exactly one gallon of gas or alternatively, the user can dispense the gasoline until the price per gallon on the pump equals the advertised price per gallon. The user then reads the temperature of the dispensed gasoline on the thermometer 62 located atop the spout edge of the container 10 and refers to the indicia on the left side of the sight glass to compare the level of the liquid in the container 10 with the line associated with the temperature displayed on the thermometer 62 in the container's graduated neck extension 50. From this comparison, a conclusion can be made whether the dispensing pump is correctly dispensing the proper volume of gasoline that was paid for.

Between the base 51 of the graduated neck extension 50 and the threaded flange inlet 22 is a seal 40. The seal 40 is annular and has an outer diameter 41, an inner diameter 42, an upper surface 43, and a lower surface 44. The outer diameter 41 is sized such that the seal 40 fits within the base 51 of the graduated neck extension 50, and is larger than the inside diameter of the threaded flange inlet 22. The inner diameter 42 of the seal 40 is sized such that the seal 40 does not block fluid communication between the container body 20 and the graduated neck extension 50. Therefore, the inner diameter 42 of the seal 40 is smaller than the inner diameter of the threaded flange inlet 22, and is larger than the inner diameter of the body 52 of the graduated neck extension 50. When the seal 40 is used in conjunction with the graduated neck extension 50 and the container body 20, the seal 40 has its upper surface 43 in contact with the base shoulder 56 of the graduated neck extension 50 and the lower surface is in contact with the top edge 24 of the threaded flange inlet 22 such that when tightening the graduated neck extension 50 to the container body 20 through engagement of the thread, the seal 40 is compressed enough to keep any liquid from escaping through the threaded joint of the graduated neck extension 50 and the container body 20. A typical seal 40 is made of a rubber based compound which is corrosion free and will not degrade by exposure to gasoline, kerosene, diesel fuel, or the like. One skilled in the art may choose to use a seal from a number of possible other materials which could provide a leak resistant connection between the threaded connection of the container body 20 and the graduated neck extension 50.

One ordinarily skilled in the art could easily see that if the graduated neck extension 50 is mounted to the container body 20 through a different means like gluing, welding, snapping, or pressing, that the seal 40 may not be required as long as the attachment means provides a sealed connection of the two pieces. Additionally, if the graduated neck extension 50 is integrally molded with the container body 20, as shown in FIG. 4, the base 51 of the graduated neck extension 50 and seal 40 is no longer required.

The container cover 66 has a cover base 68, and a cover body 70. The cover base 61 is cylindrical in shape and is larger in diameter than the neck extension spout 55. The cover base 61 has an internal thread which is complimentary to the threaded spout 55, and is intended to cooperate with the thread on the spout such that the cover can be secured to the spout. The cover body 70 is round in shape and forms a closed cup. The cover body 70 has the same axis as the cover base 68.

In accordance with the present invention, the preferred method of use involves the container combination detailed above which is filled by removing the cover 66, temperature gage 62, and rim gasket 60 from the spout 55 and filling the container body 20 and graduated neck extension 50 with exactly one gallon of the desired liquid (i.e. gasoline). After filling with exactly one gallon of gasoline by the method earlier set forth, the user is able to validate the amount of liquid dispensed in the container body 20 and graduated neck extension 50 by sighting the level of the liquid through the sight window 53 of the graduated neck extension 50, reading the temperature of the dispensed liquid on the thermometer or temperature gage 62 atop the graduated neck extension 50 and then compare the line indication for the same temperature from the indicia with the liquid level line of the fluid in the container 10. The comparison allows the user to determine whether the amount dispensed is the correct amount paid for at the pump. Alternatively, the user may discover that the amount dispensed is actually greater than paid for since the pump is not adjusted for temperature expansion of the gasoline at retail levels. Alternatively, the container can be filled by requesting that the pump dispense exactly one gallon of gasoline or measured by the attendant and do the step-by-step comparison outlined above or the user can fill the container until the dollar amount on the pump is exactly the same as the advertised price per gallon and again perform the step-by-step comparison outlined above to determine whether the pump is accurately dispensing the correct amount of gasoline. This will allow a user of the container 20 to identify if they are being defrauded through errant pumps so as to report this to the proper authorities or elect not to use that service station. After filling the container 20, the user seals the container 20 with the cover 66, allowing the user to lift and transport the container safely with the handle 30 in a vehicle.

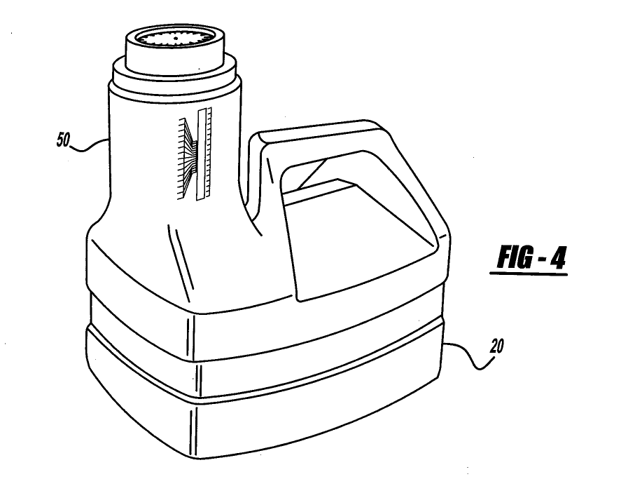

Referring to FIG. 3 and FIG. 4, there is shown two alternative embodiments where the union or attachment of the graduated neck extension 50 and container body 20 have been made by two different means. In FIG. 3, the graduated neck extension 50 is attached to the container body 20 by a sonic welding process of the HDPE material. In FIG. 4, the graduated neck extension 50 is molded directly to the container body 20. Both of these alternative processes enable the elimination of the seal 40, the threaded flange 22 and thread stop tab 25 of the container body 20, and the threaded base 51 of the graduated neck extension 50.

While the present invention has been described in terms of a preferred embodiment, it is apparent that other forms can be adopted by one skilled in the art. For example the teachings of the present invention encompass any reasonable substitutions or equivalents of claim limitations. Examples include the shape and attachment means for the graduated neck extension 50, the material of the container 10, the shape and size of the container body 21, graduated neck extension 50, and cover 60. Those skilled in the art will appreciate that other applications, including those outside of the validation and storage of fuels, are possible with this invention. Accordingly, the present invention is not limited to only use with gasoline, diesel fuel, or kerosene. Accordingly, the scope of the present invention is to be limited only by the following claims.

What is claimed is:

1. A refillable container apparatus comprising:
a container body adapted to receive a liquid;
a graduated neck extension member attached to said container body, said graduated neck extension member having a sight glass disposed along its longitudinal axis, one end of said graduated neck extension member attached to said container body and an opposite end having an outlet there at;
means for attaching said one end of said graduated neck extension member to said container body;
means for displaying the temperature of the contents of said container body, said displaying means mounted to said graduated neck extension member; and
means for validating the actual amount of said liquid received within said container body and said graduated neck extension member from a dispensing device set to dispense a predetermined amount of fluid.

2. The refillable container apparatus as claimed in claim 1, further comprising a handle member attached to said container body for aiding in lifting and transporting said refillable container apparatus.

3. The refillable container apparatus as claimed in claim 1, wherein said container body further comprises:
a bottom for stable resting said refillable container device on a flat support surface;
a top opposite of said bottom; and
an inlet located in said top of said container body.

4. The refillable container apparatus as claimed in claim 1, wherein said graduated neck extension member further comprises:
a body;
said one end of said graduated neck extension member providing fluid communication between said inlet in said top of said container body and said graduated extension neck member; and
said opposite end of said graduated neck extension member defining a spout for relieving said liquid from a liquid dispensing pump, said spout further serving as an outlet when said liquid is removed from said container body.

5. The refillable container apparatus as claimed in claim 1 wherein said means for displaying further comprises:
a rim gasket member mounted to said spout;
a temperature gage intimately contiguous said rim gasket member; and
a cover member detachably engaging said spout of said graduated neck extension member, said cover member creating an interference fit with the diameter of said rim gasket such that as said cover member is removed from said spout, said interference fit creates frictional contact with the periphery of said rim gasket such that said rim gasket and temperature gage travel with said cover member when said cover member is removed from said spout.

6. A refillable container apparatus comprising:
a container body having:
a bottom for stable resting of said refillable container apparatus upon a flat support surface or on flat ground;
a top opposite of said bottom;
an inlet located in said top;
a handle attached to said top of said container body for aiding in lifting and transporting said refillable container apparatus;
a graduated neck extension member coaxially aligned to said inlet of said container body and attached to said container body for viewing and validating the liquid amount within said container body and said graduated neck extension member when filling said refillable container apparatus to a predetermined amount of said liquid;
means for attaching said graduated neck extension member to said container body;
means for displaying the temperature of said liquid in said container body, said displaying means mounted to said graduated neck extension member; and
means for validating the actual amount of said liquid received within said container body and said graduated neck extension member from a dispensing device set to dispense a predetermined amount of said liquid.

7. A refillable container apparatus comprising:
a container body;
a graduated neck extension member having one end attached to said container body, said graduated neck extension member having a sight glass therein whereby when a predetermined volume of liquid is placed into said container body and said graduated neck extension member by a dispensing apparatus, the level of fluid may be viewed by a user through said sight glass such that a validation can be made by the user to ensure the correct volume of liquid is being dispensed by the dispensing apparatus;
means for attaching said graduated neck extension member to said container body;
a handle attached to said container body to transport said container body to and from said dispensing apparatus;
means for displaying the temperature of said liquid in said refillable container apparatus, said displaying means mounted to said graduated neck extension member; and
means for validating the actual amount of liquid received within said container body and said graduated neck extension member from a dispensing device set to dispense a predetermined amount of liquid.
